(19) United States
(12) Patent Application Publication
(10) Pub. No.: US 2009/0234958 A1
(43) Pub. Date: Sep. 17, 2009

(54) System for Processing Context Data

(76) Inventor: Habin Lee, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 11/887,765

(22) PCT Filed: Mar. 30, 2006
(86) PCT No.: PCT/GB2006/001165

§ 371 Date: Oct. 3, 2007

(30) Foreign Application Priority Data
Apr. 4, 2005 (EP) 05252100.2
Apr. 6, 2005 (EP) 05252158.0

(51) Int. Cl. G06F 15/16

(52) U.S. Cl. 709/230

(57) ABSTRACT

A system for processing context data comprising means for receiving context data from a plurality of sources; means for producing context information from the received context data according to a predetermined rule-set including a plurality of rules; and means for communicating the context information to at least one application, wherein the system includes means for permitting at least one protocol-source to specify instructions and/or rules related to a communication protocol for communication between the protocol-source and the system, thereby updating the means for receiving and/or the means for communicating. The system further includes means for permitting at least one rule-source to specify at least one rule thereby updating the rule-set, wherein the rule-source specifies rules for filtering and/or formatting the context data and rules for producing context information from context data. The system is used in a network (FIG. 4) for processing context data. One or more systems are implemented on a wireless apparatus.

The invention relates to a system for processing context data, which is related to the environment, to notify applications when a particular condition is met. The system may be implemented in a portable wireless apparatus and included in a network for processing context data for use with a work management system.

### BACKGROUND

Knowing a computing device's context can be useful in providing services based on time and location. In a simple example, a computing device may receive location data from a Global Positioning Satellite (GPS) receiver. This data is usually referred to as context data. An application may use this context data to determine the location of a user and provide a useful service based on that location.

To provide these useful services, the hardware (e.g. GPS receiver) or software providing context data is typically called a context source, hereinafter referred to as a source, which measures an aspect of its environment (its context) to produce context data. Many applications have been written that use context data as in the Cyberguide and GUIDE projects [Gregory D. Abowd et. al., “Cyberguide: A Mobile Context-Aware Tour Guide”, Wireless Networks, 3(5):421-433, October 1997] [Nigel Davies et. al., “Caches in the Air: Disseminating Tourist Information in the GUIDE System”, in WMCSA, New Orleans, La., IEEE Computer Society Press].

These projects have produced applications, which have context-aware features, that reside in portable units providing location or time based services. For example, the units can act as tour guides for interactively guiding tourists around tourist sites or cities. Although they provide interactive services, their context aware features are not re-configurable, without a large investment in re-design, if additional new sources providing new context data are required.

On the other hand, systems for processing context data have been designed that produce context information, based on context data, according to predefined business rule-sets whereby the context information can be distributed to applications requesting it. A simple example of context information based on context data such as the location and time data obtained from a GPS receiver could be information like “the technician has stayed at the same location for 30 minutes” or “the user is now late”, which is sent to the application in an appropriate format. An application requesting and receiving such information may then use it accordingly to provide a location based service, for example, automatically optimising/updating a field engineer's schedule, controlling the deployment of an organisation's workforce, or showing a user nearby shops that are open or likely to be of interest.

These systems have prompted software developers to implement applications with context aware features by using predefined software toolkits for providing context data support, for example the software library called the “Context Toolkit” [Anind K Dey, “Providing Architectural Support for Building Context-Aware Applications”, PhD Thesis, November 2000, Georgia Institute of Technology].

However, it has been frequently reported that the systems and applications developed to work with these software toolkits cannot fully satisfy the aims of:—being hardware, operating system, and programming language independent; or adequately providing for improved capabilities of maintenance and evolution; and fully sharing additional sources, processing power, context data and services [Jason I Hong and James A Landay, “An Infrastructure Approach to Context-Aware Computing”, Human Computer Interaction, 16 (2, 3 & 4), 287-303, 2001].

US 2004/0111397 A1 and EP 1217857 A2 disclose systems for processing context data that receive context data from numerous sources and send context information to numerous applications.

The system disclosed in US 2004/0111397 A1 focuses on fusing context data for use by applications. Context data from similar sources are grouped together and then aggregated. For each group, a single context value and single quality value is computed to reduce the likelihood of ambiguous context information.

In EP 1217857 A2, a system for processing context data is applied to control various applications within a vehicle depending on the user's and/or vehicle's context. Once the context is determined, a set of policies is executed and then enforced. This technique has been extended in US 2002/0124067 A1 for use in portable devices, such as laptops, where the enterprise policies are executed on a laptop depending on a user's location. The policies may control access to electronic files when a user moves location, for example.

However, although these systems communicate with sources and applications having context aware features, the communication is only provided by hard-coded application programming interfaces (API). This severely limits these systems to only those sources and applications that have been written specifically to communicate with them. These systems also use their own procedures for the flow of context data and context information. Thus the APIs, and hence both disclosed systems, need to be redesigned should additional “non-conforming” or proprietary sources, or “non-conforming” or proprietary applications supporting context aware features be required.

If additional rules for producing additional context information from context data are to be added to the abovementioned systems, the systems have to be redeveloped, for example, by rewriting and recompiling the software.

In addition, the aforementioned systems were attempts at standardising sources and the communication functions with applications that provide context aware features. However, for each organisation that requires applications that provide context aware features, context data related to various sources may be collected differently, for different reasons, in different formats, from different types of computing devices, using different communication protocols. As context aware computing matures, developers and organisations requiring context aware features are faced with a costly hurdle in updating their systems to overcome the prevalent use of, or need for, additional, non-standardised, or legacy sources and applications.

Aspects of the invention are set out in the accompanying claims.

In a further aspect of the invention, a system for processing context data is provided which includes means for receiving context data from a plurality of sources; means for producing context information from the received context data according to a predetermined rule-set including a plurality of rules; and means for communicating the context information to at least one application, wherein the system further includes means for permitting at least one protocol-source to specify a new communication protocol for future communication between the system and the protocol-source thereby updating the means for receiving and communicating. The new communication protocol is dynamically provided during runtime of the system.

Entities such as sources (context data sources), means for collecting context data, and applications or components thereof can act as protocol-sources by providing the functionalities to specify and communicate new communication protocols. Examples of applications facilitating the communication of new communication protocols are directory service applications or applications with context aware features. The ability of protocol-sources to communicate new communication protocol information to the system allows additional applications or sources to be incorporated into the system to update the means for receiving and communicating context data and context information without the need for redevelopment. This provides the added functionality of the system handling additional, non-standard or legacy sources and applications. The new communication protocol information, which may further include new code that implements the new communication protocol, can be loaded into system memory dynamically during system runtime allowing the system to remain operational.

The system may further include a protocol registry for storing the new communication protocols. In addition, the new entities such as sources, means for collecting context data or applications, (acting as protocol-sources) transmit new code that performs an implementation of the communication protocol, which can be stored in the protocol registry. This dynamically provides the system with the appropriate communication protocol and code implementing the communication protocol that specifies how the system should communicate with each entity. The necessary programs or links thereto, for implementing that entities communication protocol are further provided. This allows protocol implementations such as executable files, for example the inetd program, standard communication protocols such as the transmission control protocol/internet protocol (TCP/IP), or custom communication protocols and protocol implementations, to be incorporated into the system dynamically and during runtime.

The code that performs the implementation of the communication protocol may be given in a platform independent format, such as byte-code format or interpreter based formats like XML. This allows the system to be hardware, operating system, and programming language independent and provides the capability of future maintenance and evolution without costly redevelopment of the system.

In addition, the protocol registry allows the communication protocols communicated by the entities (acting as protocol-sources) to be stored in a secure place such as a central server. This provides added security ensuring the system for processing context data has access to legitimate sources and applications.

In another aspect of the invention, a system for processing context data is provided which includes means for receiving context data from a plurality of sources; means for producing context information from the received context data according to a predetermined rule-set including a plurality of rules; and means for communicating the context information to at least one application, wherein the system further includes means for permitting at least one rule-source to specify at least one rule, that can be dynamically provided during run-time, thereby updating the rule-set, wherein the rule-source specifies rules and/or rule related data for filtering and/or formatting the context data.

The rule-sources can be, among other things, context data sources, applications with context aware features, or other applications acting as facilitators for the provision of rules and/or rule related data. As the rule-source specifies rules and/or rule related data for filtering and/or formatting the context data, this allows the system to handle rule-sources that provide uniquely formatted context data. The rule-source specifies additional rules and/or related data to add to the rule-set, the rules of additional or updated applications and/or sources are then incorporated into the system without the need for recompiling or redevelopment of the system. That is, these rules and/or related data can be loaded into system memory dynamically while the system is in operation, or in system runtime.

Preferably, the rules determined by the rule-source further include rules for producing context information from context data. This allows applications with context aware features to provide additional rules for processing context data into context information. The rules specified by the rule-source may further relate to either the receipt by the system of context data or to the processing of context data to produce context information.

Where the rule-source determines a rule and/or related data for receiving context data, additional sources that provide context data can be handled by the system. This allows the system to be updated to deal with the format of the context data of additional sources dynamically by specifying, for example, the manner in which the context data is to be filtered and/or formatted to enable processing the context data.

The system may further include at least one registry for storing rules specified by the rule-source. This may include a first registry for storing rules for filtering and/or formatting context data and a second registry for storing rules for producing context information. The first registry also stores rules and related data for formatting/filtering context data that are further provided by sources (context sources) and/or applications facilitating a directory service. The second registry also stores rules and related data for operating on formatted context data further provided by applications with context aware features. In addition, applications with context aware, features may provide further rules and related data for handling rules and/or data related to requests of context information that are stored in the second registry.

By providing registries, the additional rules and/or related data, which are required when additional sources and applications are added or removed from the system, will update the system without the need for redeveloping or redeploying the system. A registry system can provide further mechanisms for the validation of legitimate sources providing context data ensuring the reliability and security of the system.

The system for processing context data may include means for notifying the application when a predetermined requirement or one or more rule conditions are met. This allows the system to be dynamically configured to notify an application when one or more conditions are satisfied when context data is processed. The system may further include an interest registry for storing the rules that determine the predetermined requirements of the applications.

The predetermined requirement can be at least partly determined by the rules and/or rule related data specified by the rule-source, where these rules can further be additional rules related to requests for context information, or data related to requests for context information. Applications can specify rules and/or data relating to requests for context information during system runtime.

Where the rule-source specifies a rule for the processing of context data to produce the context information, the system can incorporate the additional rules, which implement the notification of an application's request for context information. This can be done dynamically and without the need to redevelop the engine.

In further aspects of the invention, the system for processing context data may include means for collecting context data. Preferably, the system also includes means for translating the context data provided by the sources and for providing the context data to the system. The translating means may be a wrapper program. This allows sources not specifically designed to operate with the system to be dynamically added to the system without the need to rewrite the system.

The collecting means and/or translating means may be incorporated into a hardware or software sensor, which can also be a component of a source or application. This allows for the provision of improved maintenance and evolution capabilities and the ability to share sources, sensors and context data.

A network for processing context data which includes at least one system for processing context data with any combination of the features as described above, a plurality of data sources for supplying context data to at least one of the systems for processing context data and a plurality of applications for receiving context information from at least one of the systems in the network.

The network including at least one wireless device with at least one of the systems for processing context data installed. The network may further include at least one data source (e.g. context data sources) and/or at least one of the applications being implemented on the wireless device. Alternatively, the data source may be implemented on an additional external device. In conjunction with applications like work management systems, this network can provide for the efficient deployment of an organisation's workforce.

Preferred features of the present invention will now be described, purely by way of example, with reference to the accompanying drawings, in which:—

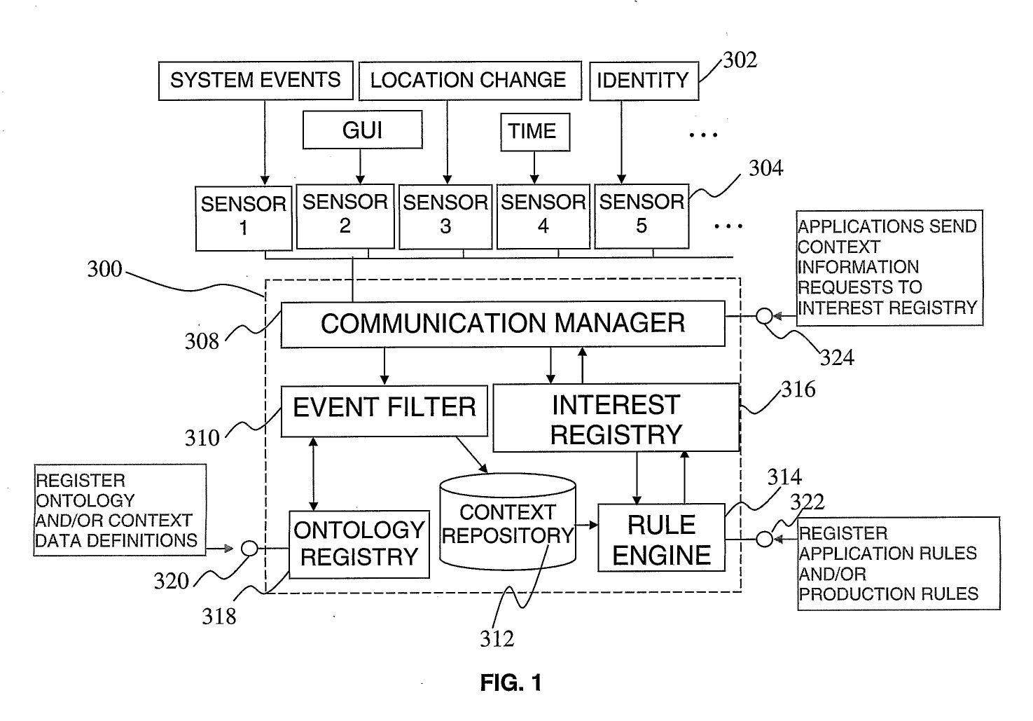

FIG. 1 illustrates a symbolic representation of a system for processing context data.

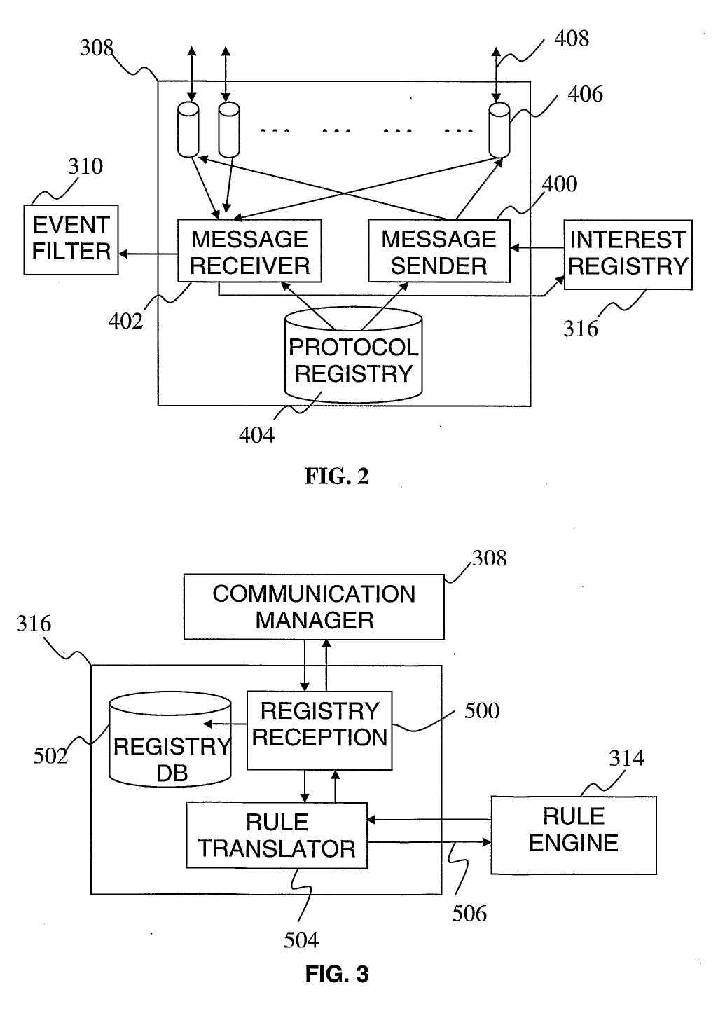

FIG. 2 illustrates the communication manager of the system of FIG. 1.

FIG. 3 illustrates the interest registry of the system of FIG. 1.

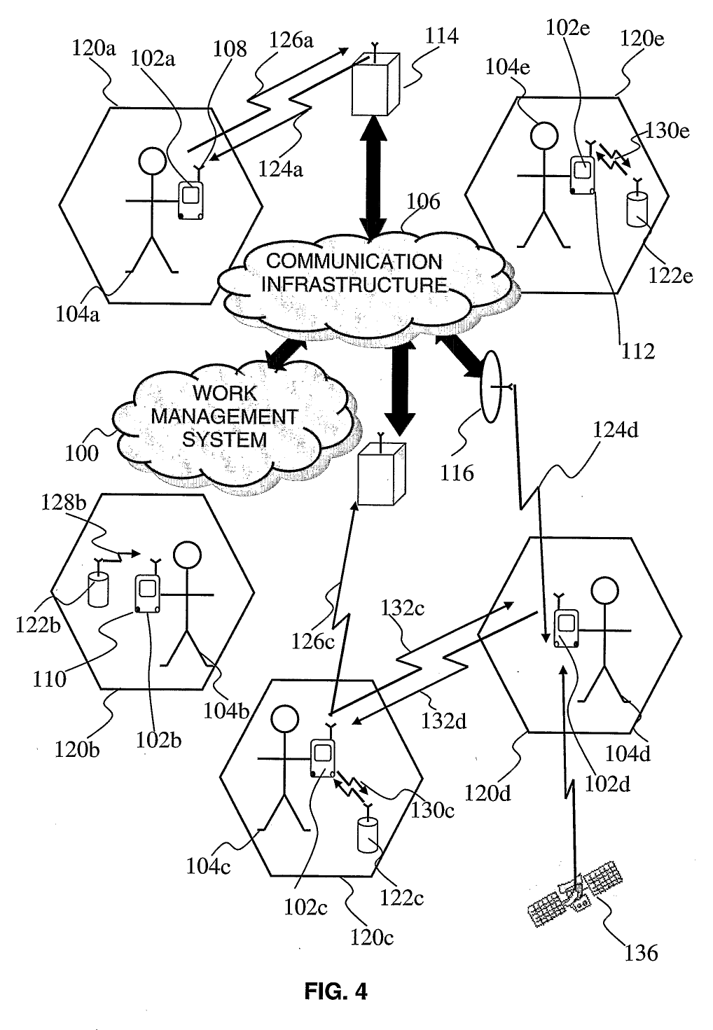

FIG. 4 illustrates a preferred embodiment of a network for processing context data using the system of FIG. 1 for use with a work management system.

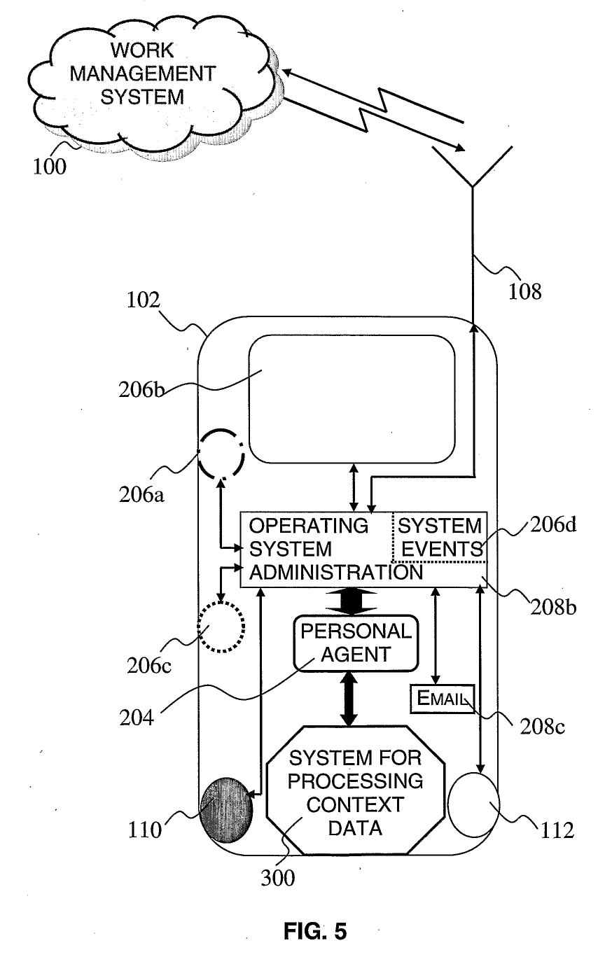

FIG. 5 illustrates a preferred embodiment of a wireless apparatus for use in the network of FIG. 4.

### SPECIFIC DESCRIPTION OF THE PREFERRED EMBODIMENTS

A symbolic representation of a system 300 for processing context data is shown in FIG. 1. A brief overview of the system 300 is now given followed by a detailed description of its components. The system 300 communicates with a plurality of context data sources 302, hereinafter referred to as sources 302, which provide context data to the context repository 312 by means of the communication manager 308, event filter 310 and ontology registry 318. The system 300 includes instructions and/or rules and related data relating to communication protocols for communication between the sources 302 and the communication manager 308 either by means of sensors 304, applications or otherwise.

The system 300 notifies an application (not shown) when a particular requirement is met. The particular requirement is calculated by the system 300 based on a rule-set. The rule-set includes rules and related data for formatting and/or filtering the context data performed in the event filter 310, which refers to the ontology registry 318. The rule-set also includes rules and related data for requests of context information given by applications (the particular requirements of the applications) which communicate with the system 300 via the communication manager 308, interest registry interface 324, rule registry interface 322 and interest registry 316. The rule-set also includes rules and related data for calculating context information from the context data in the rule engine 314.

The primary functionality of the system 300 is:—receiving context data collected by sensors 304 that act as interfaces between the sources 302 and the communication manager 308; task progress reasoning or context data processing being performed by the interaction of the system's 300 event filter 310 and rule engine 314; and the interfacing with external systems or applications (not shown) being performed by the interaction of the interface 324, communication manager 308, interest registry 316 and rule engine 314.

Initially, context data and applications having context aware features are first defined, during the design stage, by an organisation as a system specification. The required sources 302 and sensors 304 can also be defined within the system specification. As will be described, the system 300 for processing context data can be dynamically updated when additional or upgraded sources 302, sensors 304, and applications are required.

Entities such as sources 302, sensors 304 and applications need to have the functionalities of specifying new communication protocols or rules, which is they act as protocol-sources and/or rule-sources. When the entities have the functionalities of acting as protocol-sources, they will typically register new communication protocols and/or code performing an implementation of the new communication protocols with the system 300. This enables communication between the entities and the system 300, to be described in more detail with reference to FIGS. 1 and 2.

When the entities have the functionalities of acting as rule-sources, they will typically register rules and/or data, such as rules and data relating to:—the formatting and/or filtering of context data; the processing of context data to produce context information; and requests for context information. This enables the system 300 to process context data and to distribute context information dynamically, to be described in more detail with reference to FIGS. 1, 2 and 3.

Referring to FIG. 1, context data is collected from sources 302 by the sensors 304. The communication between the system 300 and a sensor 304 is performed via methods depending on the implementation platform of the sensor 304. The method of communication by the system 300 with sensors 304 and applications will be discussed in more detail in FIG. 2.

The system 300 can be implemented on a computing device, which typically includes one or more processors, computer-readable media, for example, hard disk and/or floppy disk drives other storage media and memory, and software executable on the one or more processors that cause the processors to implement a programmed function. In some embodiments, the system 300 for processing context data may be implemented on one or more computing devices which may be, but are not limited to, one or more mobile computing devices such as laptop computers or handheld computing devices such as mobile telephones, palm held personal computers (palm PCs), personal digital assistants or wearable computers and the like. In other embodiments, the system 300 may be implemented on personal computers, backend workstations or servers supporting an organisation. In addition, the system 300 can be, but is not limited to, implementation on the same computing device as the sources 302, sensors 304 and applications, and as will be shown, the system 300 will communicate or operate with sources 302, sensors 304 and applications remotely located to the computing device that includes the system 300.

The primary sources 302 that are used in the system 300 are location providers such as GPS receivers or mobile location beacons and the like. Other sources 302 may, to name a few, provide time, identity information/data, system events, and the input/output of touch-screen graphical user interfaces (GUIs). The sources 302 provide context data to the sensors 304. That is, for each source 302, a sensor 304 is implemented to retrieve the required context data from at least one source 302. That is, the sensors 304 can translate the context data provided by the sources 302 into a suitable format to provide the context data to the system 300.

Alternatively, sensors 304 may be incorporated as a component/or a portion of the sources 302, allowing the source 302 to interface with the system 300. The collection of context data is performed by sensors 304, which send the context data to the communication manager 308. The collected context data is received by the communication manager 308, which is then passed onto the event filter 310.

The sensors 304 can be implemented as driver programs for the sources 302 or other customised wrapper programs, for example a sensor program implemented using CORBA (Common Object Request Broker Architecture) may be used as a wrapper program to interface with a source 302. In other realisations, a sensor 304 could be implemented as a wrapper program around a source 302 using CORBA. In these cases, the passing of collected context data from the CORBA-based sensor 304 to the system 300 can be performed via the IIOP (Internet Inter-ORB Protocol).

In a specific realisation, a sensor 304 is implemented as a software agent (sensor agent) that monitors a source 302. The necessary context data is retrieved and sent/communicated to the system 300 via an ACL (Agent Communication Language, a standard message format defined by FIPA (Foundation for Intelligent Physical Agents), an international standard organization for multi-agent systems). The collaboration with multiple sensor agents or objects across multiple computing devices enables the collection context data from the sources 302.

As another example of a sensor 304, the source 302 may be an operating system (OS) of a computing device on which the system 300 has been installed. A sensor 304 can be implemented as a sensor agent, which may collect context data or interesting events (like system events) from the OS. These system events can be, for example, the use of specific application systems, the state of the battery of the computing device, the state or type of current network connection, the list of currently active application systems on the computing device and so on.

Some of the events that occur are the arrival of context data where the system 300 receives context data from the sensors 304. The received context data is in a particular format according to the particular sensor 304 used. Thus, the event filter 310 filters these events, received context data, into fact data that is stored in the context repository 312. The fact data is based on the retrieved context data, where the event filter 310 needs to validate and filter the context data into a specific format that depends on the implementation of the rule engine 314.

The context repository 312 may be a database, data files, a filing system, or computer-readable media, for example, hard disk drive other storage devices and media, memory or other software system suitable for the storage and retrieval of the fact data.

In order to filter the received context data, the event filter 310 refers to the ontology registry 318. The ontology registry 318 is a registry of each source's 302 and/or sensor's 304 structure of context data and/or rules related to the received context data, which are referred to as context data definitions. The context data definitions enable the event filter 310 to filter the received context data into fact data. These definitions and rules for filtering the context data are implemented in the system 300 as a portion of the overall rule-set, and determine how the event filter 310 will filter the received context data to evaluate the specially formatted fact data.

However, if the context data definitions are not already defined in the registry then the system 300 cannot validate or filter the received context data. To overcome this issue, the system's 300 ontology registry 318 and requisite portion of the rule-set can be dynamically updated in real-time. In order to do this, the sources 302 and/or the sensors 304 will specify (act as a rule-source) to register their context data definitions and requisite rules with the system 300 using the ontology registry interface 320 that is connected to the ontology registry 318.

In yet other realisations, the sensor 304 does not necessarily need to stay resident after registering the context data definition of the source 302. This type or portion of a sensor 304 may simply register on start-up, (of the source 302), and then uninstall itself, allowing the source 302 to communicate with the system 300. In addition, this allows the source 302 to be implemented as a thin client on the computing device or other external device.

Furthermore, a source 302 and/or sensor 304 can dynamically be added by, instead, registering its context data definition or service with an application that provides a directory service, such as a directory facilitator or mediator. This application can then be instructed by either the source 302 and/or sensor 304 or the system 300 to register the context data definition and/or the associated rules on behalf of the source 302 or sensor 304 either via the ontology register interface 320 or through other means. Alternatively, a system administrator application may enter the required definition using the ontology registry interface 320.

In addition, if a sensor 304 is installed, the sensor's 304 installation program may interface with the system 300 to provide the context data definition the sensor 304 uses to send context data to the communication manager 308. The methods in which a sensor 304 and/or source 302 can register a context data definition with the system 300 are not limited to that described above.

Once validation and filtering of the received context data into fact data has been achieved, the fact data is stored in the context repository 312. This produces a change in the context repository 312 that triggers the rule engine 314 to process the fact data. The fact data is processed by the rule engine 314, which evaluates the rules related to producing context information from the context data. These rules are stored within a rule registry (not shown) and are also known as rule scripts or production rules which may be in the form of an IF <condition> THEN <action> structure.

Initially, there is a predetermined rule-set including a plurality of rules that are stored in the rule registry when the system 300 is installed. This predetermined rule-set may specify the rules relating to and satisfying, at the design/installation time of the system 300, an organisation's specific requirements for processing context data into context information. If any of the conditions, or predetermined requirements that are represented with logically linked conditions, within the rules are satisfied, then the rule engine 314 will execute the <action> portions of the rules.

These <action> portions will at times generate mid-level and/or higher-level context information and are further stored in the context repository 312 as additional fact data. The lowest level context information is, in fact based directly on the context data. For example, the context data can be based on identity (user number 2), time (30 minutes) and location data (latitude/longitude co-ordinates), and mid-level context information can be, for example, “user 2 has been at the latitude/longitude co-ordinates for 20 minutes”, and higher-level context information can be, for example, “user 2 is late” or “user 2 is in danger”. An application may make a request for any level of context information i.e. either low/mid or higher-level context information.

Recently generated mid/higher-level or stored low-level context information can influence other rules and, as a result, the rule engine 314 will need to re-process the fact data (which may now include the generated mid/higher-level context information and low-level context information such as context data) by re-evaluating the rules.

The rules of the rule-set related to the rule engine 314 are stored and registered in a rule registry (not shown). The receipt/registration of these rules is achieved via the rule registry interface 322. However, among other rule-sources, applications may also register additional rules that are specific to the context information required by that application. The rule engine 314 executes the rules stored in the rule registry based on the collected fact data to generate the mid/higher-level context information.

Any changes made to the fact data of the context repository 312 will result in the execution (or firing) of rules that notify the change to the interest registry 316. The interest registry 316, then sends announcement messages, or if a context information request is satisfied, messages containing the context information to applications that have stored their request for context information with the interest registry 316. In this embodiment, the messages are sent to applications and other systems via the communication manager 308.

Alternatively, the rule-engine 314 may contain rules relating to notifying the applications directly when a condition is met. That is, the rule-engine 314 may even communicate the context information directly to the requesting application via the communication manager 308, bypassing the interest registry 316.

Achieving the notification of context information that is requested by an application requires that an application communicate with the system 300. The application provides the capability of functioning as a rule-source and sends rules and/or related data relating to requests for context information to the system 300. This is known as registration, or registering an applications interest or interests in context information. A subscription-based registry (not shown) is used as each request for context information is received. This registry stores information about the request for context information and its sender, i.e. the application that sent it.

In this embodiment, the subscription-based registry is located within the interest registry 316. Applications can communicate and store requests for context information with the interest registry 316 via the interest registry interface 324. In this embodiment, the interest registry interface 324 is connected to the communication manager 308.

The interest registry interface 324 may be used for other forms of communication with applications instead of only receiving context information requests (interests). Such communications can be the communication sometimes required between the communication manager 308 and an application, where the application provides the capability of functioning as a protocol-source. This is described in detail with reference to FIG. 2.

FIG. 2 illustrates a communication manager 308 for use in the system 300 of FIG. 1. The goal of the communication manager 308 is to manage all the communication with the sensors 304 (and/or sources 302) and applications. The communication manager 308 has a message sender 400, a message receiver 402, a protocol registry 404, and numerous protocol implementations 406.

Incoming messages 408 from entities such as sensors 304, sources 302 and/or applications are received by the corresponding protocol implementation 406. The incoming messages 408 are passed to the message receiver 402. Each protocol implementation provides an interface between sources 302, sensors 304 and/or applications (which possibly have capabilities of functioning as protocol-sources and/or rule-sources) and the message receiver 402. The protocol implementations 406 can be executable programs, like API's, based on the various communication protocols such as, for example the Linux program inetd that uses the TCP/IP protocol. Each protocol implementation 406 occupies a physical or logical port within the computing device that includes the system 300. The protocol registry 404 stores the various communication protocols and/or the code that performs the implementation of the communication protocols, such as the protocol implementations 406. The protocol registry 404 stores the identity of sources 302, sensors 304, and/or applications that are now known to the system 300.

New entities such as sources 302 (context data sources), sensors 304, and/or applications need to have the functionality of specifying the communications protocol they will use (acting as protocol-sources) in order to be added and registered to the system 300. This is achieved by the provision of a handshaking procedure between the communication manager 308 and the new entities. The handshaking procedure provides for, among other things:—a) requests for registration from the entity to the communication manager 308 (or in principle vice-versa), b) the registration of new entities which will be communicating with known communication protocols with the communication manager 308, or c) entities with new communication protocols which will be able to specify, by transmitting to the communication manager 308, the required new communication protocol and register accordingly. This ensures the system 300 can communicate with new sources 302, sensors 304, and/or applications in the future and remain operational.

Initially, a common communication protocol is used to initiate communication between the communication manager 308 and the new entity. Typically, this communication will be via a designated communication port that is used for registering entities. The entity notifies the communication manager 308 of the new communication protocol that it will use for future communications. The communication manager 308 then searches the protocol registry 404 for a communication protocol that matches. If the communication protocol and code is known to the communication manager 308, i.e. it is stored in the protocol registry 404 or found in another similar location within system 300, the communication manager 308 simply registers the entity in the protocol registry 404.

As the communication manager 308 now has the ability to communicate with the entity, it allocates a specified communications port to the entity for future communication. If necessary, this communications port may possibly be shared among other entities. This keeps the designated communication port free for new entities to register with the communication manager 308. The communications ports can be, among other things, network ports.

On the other hand, if the communication manager 308 determines that the entities new communication protocol is not already stored within the protocol registry 404 then the communication manager 308 notifies the entity with a request for the transmission of the required new communication protocol information. The new entity will then transmit the new communication protocol information (including new code for implementing the communication protocol) to the communication manager 308.

Once the transmitted new communication protocol information is stored in the protocol registry 404 the communication manager 308, then registers the entity, i.e. identification information etc., with the protocol registry 404 or another similar location within system 300. A communications port is then allocated to the protocol-source for future communication as discussed above.

In addition, the protocol registry 404 provides a secure storage facility for communication protocol information received by the communication manager 308, for example, the protocol registry 404 may be located within a central server. This provides added security ensuring the system 300 has access to legitimate entities such as sources 302, sensors 304, applications. As an example, if an entity or a third party application such as a directory service, cannot fulfil the transmission of the new communication protocol information or the identity of the entity etc., then the communication manager 308 will not register that entity or store its communication protocol information.

The code that performs an implementation of the new communication protocol may be given in a platform independent format, such as byte-code format or interpreter based formats like XML. This allows the system 300 to be hardware, operating system, and programming language independent and provides the capability of future maintenance and evolution without costly redevelopment of the system 300.

It should be noted, that after the registration of a new entity such as a new source 302 and/or a sensor 304 that provides new context data, the format of the received context data may be unknown, i.e. the context data definition may also be new to the system 300. As a result, the event filter 310 and ontology registry 318 may require updating as was described previously with reference to FIG. 1. That is, referring back to FIG. 1, the new sources 302 and/or sensors 304 will need to provide the capability of functioning as a rule-source. Alternatively, a third party rule-source, such as a directory service, could act on their behalf. The new source's 302 and/or sensor's 304 context data definitions and requisite rules may be stored and registered with the system 300 using the ontology registry interface 320 that is connected to the ontology registry 318.

Referring back to FIG. 2, each protocol implementation 406 receives an incoming message 408 that follows a particular protocol. These incoming messages are converted by the protocol implementation 406 into messages that can be understood by the system 300.

Firstly, each incoming message 408 is received via one of the protocol implementations 406. The incoming message 408 contains at least two types of information:—the sender of the message (that is, for example, the source 302, sensor 304, and or application that sent the message) and the message content. As an example, if the sender of the message is a sensor 304, and/or the message content relates to context data, then the message receiver 402 will forward the converted message to the event filter 310 for validation and filtering into fact data.

Alternatively, if the sender of the message is an application, and/or the message content relates to a request for context information, then the message receiver 402 will forward it to the interest registry 316, where the sender of the message's request is registered in the subscription registry.

An example of an ACL message that may be received by a protocol implementation 406 from a source 302 or a sensor 304 is shown below.

(Inform
:sender (agent-identifier :name gps@pda.com :address
iiop://pda.bt.com/acc)
:receiver (agent-identifier :name context_engine@pda.com :address
iiop://pda.bt.com/md)
:language FIPA-SL0
:protocol FIPA-Inform
:ontology Context-Management
:content

(contextchanged

(data

(ontology TravelManagement)
(Location (x-coordinate 2093093)(y-coordinate 3087239)))))

In this example, the protocol implementation 406 communicates with a FIPA agent and the message may have the form shown above. On receiving the message, the protocol implementation 406 will remove the ACL message content. As can be seen in this example, the predicate name of the content is “ContextChanged”, and the protocol implementation 406 can identify that this content is aimed for event filter 310.

With reference to FIG. 1, the content of the ACL message is sent to the event filter 310, where it is filtered into fact data before being inserted into the context repository 312. The event filter 310 will need to look up the rules and context data definitions within the ontology registry 318 to validate the received data. This ensures that only legitimate data is inserted into the context repository 312. On successful validation and filtering, the event filter 310 enters the fact-data into the context repository 312 using an API provided by the context repository 312.

The context handling logic within the system 300 consists of two parts: the context data definition part and context handling rules or rules related to the rule-engine 314. The context data definition part is registered in the ontology registry 320 via provided APIs or ontology interfaces 320. The context handling rules are registered in the rule engine's 314 rule registry (not shown) via the rule registry interface 322.

A language syntax that defines context data definitions and handling logic is dependent on the specific implementation of the rule engine 314 used. Any type of rule engine 314 may be used in system 202. In this symbolic embodiment, the rule engine 314 that is used is the JESS (Java Expert System Shell, http://herzberg.ca.sandia.gov/jess/) engine. In this case, the portion of the rule-set related to the rule engine 314 are rules in the JESS format (written as rule scripts) which are provided by either rule-sources, such as applications versed in the JESS syntax, or the predetermined rules entered by the system developer during design time.

An example of a context data definition that can form an entry in the ontology registry 318 is shown below.

<Ontology name=TravelManagement>

<Entity>

<Name>Location</Name>
<Slot>

<Name>x-coordinate</Name>
<Type>NUMBER</Type>

</Slot>
<Slot>

<Name>y-coordinate</Name>
<Type>NUMBER</Type>

</Slot>

</Entity>

<Entity>

<Name>Job</Name>
<Slot>

<Name>Id</Name>
<Type>STRING</Type>

</Slot>
<Slot>

<Name>Status</Name>
<Type>STRING</Type>

</Slot>

</Entity>

</Ontology>

Another example of the above context data definition is shown below in JESS syntax. The name of the entry in the ontology registry 318 can be the name of the JESS file to allow easy loading of the context data definition by the event filter 310.

TravelManagement.clp
(deftemplate Location
(slot x-coordinate (type STRING))
(slot y-coordinate (type STRING))
)
(deftemplate Job
(slot id (type STRING))
(slot status (type STRING))
)
...

The context handling rules, i.e. the portion of the rule-set related to the rule engine 314, takes the form of IF-THEN production rules. Such production rules consist of two parts: 1) the condition part and 2) the action part. The condition part is used to define a condition that specifies the designated state of some fact data (derived from received context data). If the condition is satisfied, then the action part is executed.

An exemplary production rule for the JESS rule engine 314 is illustrated in the production rule fragment below.

(defrule from-activated-to-executing
(salience 70)
(Job (id ?jid)(status Ongoing))
(Customer (location ?cl)(job_id ?jid))
(CurrentLocation (location ?ccl))

(around ?cl ?ccl)

=>
(update (Job (id ?jid)(status Completed)))

Typically, the action part would comprise functions that modify the progress of a job status or mid-level context information or fact data. In general, a large number of rules will be defined to specify the fact data processing logic for each organisation and/or application. There are two types of generic production rules, 1) a mid-level context rule and 2) a higher-level context rule. A mid-level context rule produces (or updates) mid-level context information based on the change of fact data (i.e. the change in context data collected from the sources/sensors 302/304). Higher-level context rules will produce (or update) higher-level context information based upon mid-level context information and/or fact data.

The context data is the data that is collected by a sensor 304 or sent by a source 302 (if no sensor 304 is available, or the sensor 304 and source 302 are combined) while context information is generated by processing the fact data (which is based on context data) and/or context information (stored as fact data).

As an example, the location and time data obtained from a GPS system is context data, while “the user stayed at the same location for 30 minutes” is mid-level context information, whereby higher-level context information derived from the mid-level context information may be “the user will be late” or “the user is in danger”, or some other statement.

FIG. 3 illustrates an interest registry 316 for use in the system 300 of FIG. 1. The interest registry 316 is the mechanism with which rule-sources, for example applications with the capabilities of functioning as rule-sources, can register their predetermine requirements, rules and/or related data relating to context information and requests for context information, an interest registration entry. The rule-sources that register are called registrants and all registrants of the interest registry 316 will receive notification messages if context information is available that satisfies the conditions imposed by their predetermined requirements, rules and/or related data.

As shown in FIG. 3, the interest registry 316 has a registry reception 500 that communicates with the communication manager 308. The registry reception 500 either receives an interest registration entry (e.g. predetermined requirements, rules and/or related data relating to requests for context information) from a rule-source or sends a notification message (e.g. message containing context information) to the corresponding rule-source, for example an application.

On receiving a rule or related data relating to a request for context information, the registry reception 500 will retrieve the content of the request for context information and insert it into permanent storage in a registry database (DB) 502. Registry reception 500 then invokes a rule-translator 504 that produces an invocation rule, represented by line 506. This invocation rule can be input into the rule registry of the rule engine 314. The invocation rule will then trigger the rule engine 314 into notifying the interest registry 316 to send notification message back to the registrant when its predetermined requirement or rule is met. Alternatively, the invocation rule can trigger the rule engine 314 into notifying rule-source by sending a notification message back to the registrant when its predetermined requirement or rule is satisfied.

A request for context information sent by a rule-source, e.g. an application with context aware features, to the interest registry, (i.e. an interest registration entry or rule and/or related data relating to a context information request) is shown below.

<InterestRegistry>

<Registrant>

<Type>FIPA-AGENT</Type>
<Name> personalagent-

10023043@mpower.com.bt</Name>

<Address>iiop://mpower.com.bt/acc</Address>

</Registrant>
<ContextInformation>

<Ontology>TravelManagement<Ontology>
<Entity>Job</Entity>
<Slot>

<Name>Status</Name>
<UpdateType>REACHED</UpdateType>
<Value>Completed</Value>

</Slot>

</ContextInformation>

</InterestRegistry>

This request consists of two main parts: the recipient part and the context information part. The recipient part contains information regarding the registrant, (i.e. the application), and the protocol implementation it wants to use to communicate with, which may be an agent or any other component such as CORBA, Component Object Model, or Enterprise Java Beans, for example. The context information part defines the context information that interests the registrant.

In the above request for context information, the registrant is an application that uses a FIPA compliant software agent that is running in the address of iiop://mpower.com.bt/acc. The agent, personalagent-10023043@mpower.com.bt, is interested in the status slot value of all Job objects defined in the TravelManagement ontology, given by the previous ontology registry entry. In particular, the agent wishes to be notified when the status slot has “Completed” as its value.

An example of an invocation rule is shown below which is a portion of the rule-set related to notifying the rule-source of requested context-information.

(defrule notify-external-application
(Job (Id ?jid)(Status COMPLETED))
=>
(Notify personalagent-10023043@mpower.com.bt ?jid))

In this invocation rule definition, ‘Notify’ is a system function that will call an API provided by registry reception 500 to send a notification message to the recipient/registrant by providing the specified arguments: recipient and context information.

Referring back to FIG. 2, the communication with rule-sources, e.g. applications, is performed via the communication manager 308. This works by having the rule-source send a rule and/or related data or an interest registry subscription message relating to a request for context information. This message is received by message receiver 402 and then passed to the interest registry 314. When the context information request is fulfilled, a notification message containing the recipient and the context information is passed to message sender 400 and is sent out to the designated rule-source, e.g. application that had registered its request to the context information.

Before sending, the message sender 400 first checks the required protocol to send/communicate the message to the recipient by querying the protocol registry 404. The protocol registry 404 returns an object reference of the installed protocol implementation 406 if the protocol implementation 406 has been registered. The message sender 400 will then use the object reference to invoke the required protocol implementation 406. The method of invocation is done via a predefined interface definition that defines all the methods that should be implemented by any protocol implementation 406.

An example of an interface that would be implemented by the corresponding protocol implementation 406 is shown in the following code fragment.

Interface ProtocolImplementation {

Boolean sendMessage(Message msg);}

Referring to FIG. 4, an illustration of a preferred embodiment of a network for processing context data is shown. This is used in conjunction with an organisation's work management system 100. The system 300 for processing context data (called system, and not shown in this Figure) is provided as a program on each portable device (PD) 102a to 102e, (for more details refer back to FIG. 1).

The PDs 102a to 102e are carried by the organisation's workforce 104a to 104e and will have access to a common communication infrastructure 106 via various interfaces/communication elements like mobile terminal antennae 108, infrared antennae/connections 110, or a wireless LAN interfaces 112, to name a few. Networked to the common communication infrastructure 106 are various communication elements like mobile base-stations 114, or wireless LAN transceivers 116. These are only examples of what interfaces/elements could be used to provide access to the common communication infrastructure 106, as well, wired interfaces/elements may also used.

The work management system 100 is located onsite within the organisation, for example, within an organisation's offices or management centres. The work management system 100 also has access to the common communication infrastructure 106. The worker's locations 120a to 120e are either offsite or onsite. As an example, the workers 104a to 104e can work offsite, such as service engineers working in the field, or alternatively, the worker's locations 120a to 120e can also be onsite in and around the organisation's offices.

Context data is collected by sensors 122b, 122c, 122d, or 122e from various external sources (not shown) that are located in and around the worker's location. As has been discussed with reference to FIGS. 1, 2 and 3, the sensors 122b, 122c, 122d, or 122e can have the capability of functioning as protocol-sources. In addition to providing context data, these protocol-sources also provide the system for processing context data with the required communication protocols and code for performing an implementation of the communication protocol, and other related information, enabling the system for processing context data to communicate with the respective sensor 122b, 122c, 122d, or 122e. Other sensors or sources can be located internally on the PDs 102a to 102e, of which some examples are shown in FIG. 5.

The work management system 100 communicates with the worker 104a in location 120a via the PD 102a. The work management system 100 can be an application that has the capabilities and functions of a rule-source. Alternatively, the work management system 100 can be set-up to communicate automatically or directly with the PD 102a itself without the worker's 104a assistance.

In this case, the PD 102a is in communication with the work management system 100 via base-station 114 of the common communication infrastructure 106. The system for processing context data on PD 102a will receive a rule and/or related data relating to a request for context information, conveyed by signal 124a, from the work management system 100. This will update the rule-set contained within the system for processing context data on PD 102a. The context information requested may be the location of the worker 104a, the number of jobs/tasks completed, or some other organisation specific information, for example, information required for organising/optimising the worker's job schedule.

The rule and/or related data relating to the request for context information is conveyed by signal 124a and processed by the system for processing context information on PD 102a. If the system on PD 102a has received and processed the relevant context data received from any available sensor (not shown) then the system will notify and send the context information, in a required format, to the work management system 100, as conveyed by signal 126a. The work management system 100 receives and processes this information and takes action depending on the organisation's requirements. For example, it may send the worker 104a to a different location to perform another job.

The worker 104b in location 120b shows an example where a sensor 122b communicates context data, conveyed by signal 128b, to the PD 102b. The sensor 122b sends any collected context data in a specific format to the PD 102b. In this case, the system on PD 102b either already knew the specific format the context data was being sent in and the communication protocol that the sensor 122b uses for communication, or this information (the sensor's 122b context data formats and protocol information) has previously been communicated to the system via the initial handshake procedure as described in FIG. 2.

The PD 102c of the worker 104c at location 120c is currently sending context information, conveyed by signal 126c, to the work management system 100 via the common communication infrastructure 106. In addition, PD 102c is in communication with sensor 122c, i.e. the sensor 122c has the capabilities of also functioning as a protocol-source. In this case, the system within PD 102c is performing a handshake operation represented by signals 130c with sensor 122c which communicates/or registers with the system additional instructions and/or rules and related data relating to the specific format of the context data that sensor 122c collects, as described previously with reference to FIGS. 1 to 3. After the handshake operation, sensor 122c will then be able to send context data collected from its sources (not shown) to the system in PD 102c for processing.

In a similar manner as described above, the system of PD 102d of worker 104d in location 120d receives a rule and/or related data relating to a request for context information, conveyed by signal 124d, from the work management system 100 via the common communications infrastructure 106. As well, the system of PD 102d receives signals from a GPS satellite system 130 for the calculation of location context data within a GPS receiver located on PD 102d for collection by an onboard sensor (not shown). This sensor is located within PD 102d, and can send location information to the system on PD 102d.

In addition, there is peer-to-peer communication between PDs 102c and 102d, conveyed by signals 132c and 132d, where the PDs 102c and 102d are requesting and/or receiving context-data and/or context information from each other. In this case, PD 102c makes a request for context information, conveyed by signal 132c, from PD 102d, whereby PD 102d having already processed the request, via its own system for processing context data, provides the context information, conveyed by signal 132d. The PDs 102a to 102e themselves may act as rule-sources or protocol-sources, i.e. applications, sources, or sensors with respect to each other and/or the work management system 100.

At location 120e, the system on PD 102e is performing a similar handshaking operation with the sensor 122e that collects context data from its respective source as has similarly been described that of PD 102c above.

Examples of PDs 102a to 102e that may be used are any portable device such as a mobile phone, personal digital assistant (PDA), or laptop computer. In addition, should a PD not be capable of running or storing a system for processing context data, then the system may instead be installed on another device, i.e. located externally to the PD, yet still having the capability of interacting (i.e. receiving context data and requests for context information and sending context-information) to rule-sources via the PD or otherwise.

FIG. 5 illustrates a preferred embodiment of a portable device (PD) 102 for use in the network for processing context data of FIG. 4. A Personal Agent software program 204 controls the interaction between the system 300 for processing context data and the different sources 206a to 206d and rule-sources 100, 208b and 208c, e.g. the applications, shown in this Figure. The sensors (not shown) that collect context data from the sources 206a to 206d are implemented as software programs that are installed on the PD 102. Furthermore, PD 102 contains communication hardware such as a mobile terminal antenna 108, an infrared communication device 110, and a wireless LAN communication device 112 for communication with external entities, protocol-sources and rule-sources, such as external sources, sensors and applications like the work management system 100. The communication hardware is not limited to only wireless communication hardware, i.e. wired communication hardware can also be used to connect/access the communications infrastructure (not shown).

The sources 206a to 206d that are shown in FIG. 5 are located internally/or on the PD 102. These sources 206a to 206d could be a GPS satellite receiver 206b for providing location data, or other context data sources such as a touch screen graphical user interface 206b, a track pad 206c, and other programs/devices that generate system events 206d, to name a few. These sources 206a to 206d, communicate with their respective sensors, which are registered with the system 300.

The sensors will typically interact with the operating system administration software 208c, which in turn directs these interactions to the Personal Agent 204. The Personal Agent 204 can in fact act like a aggregate protocol-source or rule-source with system 300. That is, when required the Personal Agent 204 directs the appropriate entities, protocol-source and/or rule-source interactions, i.e. a sensor's or application's 100, 208b and 208c interactions (namely the collected context data, context data definitions, communication protocol information, rules and/or related data relating to requests for context information), to system 300 for processing context data into context information.

The rule-sources (applications) 100, 208b and 208c that are shown in FIG. 5 are a work management system 100, an email program 208b, and the operating system administration 208c. Note, in addition to being an application (rule-source), the operating system administration 208c may also have sources installed or embedded, in this example there are sources called system events 206d. The rule-sources (applications) 100, 208b and 208c send rules and/or related data relating to requests for context information to the system 300 via the Personal Agent 204. When the context information has been evaluated by the system 300, the system 300 sends the context information, in an appropriate format, to the respective rule-source (application) 100, 208b and 208c that requested the context information.

Other configurations of the Personal Agent 204 and system 300 are possible. As an example, the system 300 may be embedded within the Personal Agent 204, whereby the Personal Agent 204 may provide several functionalities that are provided by sources, sensors and/or applications (i.e. protocol-sources and rule-sources). The Personal Agent 204 could also receive context data from sources and/or sensors external to the Personal Agent 204 for, among other things, re-direction to the system 300. Similarly, the Personal Agent 204 may receive requests for context information from rule-sources, e.g. applications, external to it for, among other things, re-direction to the system 300 and as a result send the requested context information when available to the external rule-sources, e.g. applications requesting context information.

Furthermore, if a portable device (PD) 102 does not have enough processing power or memory storage for the Personal Agent 204 and/or a system 300, then the Personal Agent 204 and/or a system 300 may be implemented on a computing device external to PD 102. In this case, PD 102 may interface/communicate with the external computing device to have access to the Personal Agent 204 and/or a system 300.

In other embodiments, with reference to FIG. 2, the functionalities of new entities such as sources 302, sensors 304 and/or applications, (protocol-source components) do not necessarily need to stay resident after the handshake procedure, when the new communication protocol has been registered and stored in the protocol registry 404. This type of functionality of the entity may simply perform the handshake procedure on start-up, (i.e. start-up of a source 302, sensor 304 or application), and then the functionality uninstalls itself, allowing, for example, a source 302 to communicate with the system 300. In addition, this allows, for example, the source 302 to be implemented as a thin client on the computing device or other external device allowing the sharing of computing resources.

Furthermore, as briefly described above, a new entity (source 302, sensor 304, or application) can dynamically be added by, instead, storing its communication protocol and the code for implementing it, with an application providing, for example, a directory service such as a directory facilitator or mediator. This application can then be instructed by the respective source 302 and/or sensor 304 or the system 300 to transmit the new communication protocol and/or code for implementing it, on behalf of the source 302 or sensor 304 or application for storage in the protocol registry 404 and registration with the system 300. Alternatively, a system administrator application may enter the required communication protocol and code that performs the implementation of the communication protocol via a similar mechanism.

In addition, if a new sensor 304, for example, is installed, the sensor's 304 installation program may interface with the system 300 to provide the new communication protocol that the sensor 304 uses to send context data to the communication manager 308. The methods in which a new sensor 304 and/or source 302 can store/register its identity and new communication protocol with the system 300 are not limited to that described above.

It will be understood that the present invention extends to methods and/or apparatus substantially as herein described with reference to the accompanying drawings. Any feature in one aspect of the invention may be applied to other aspects of the invention, in any appropriate combination. In particular, method aspects may be applied to apparatus aspects, and vice versa.

In addition, the present invention has been described above purely by way of example, and modifications of detail can be made within the scope of the invention.

Each feature disclosed in the description, and (where appropriate) the claims and drawings may be provided independently or in any appropriate combination.

1. A system for processing context data comprising means for receiving context data from a plurality of sources; means for producing context information from the received context data according to a predetermined rule-set including a plurality of rules; and means for communicating the context information to at least one application, characterized in that
the system includes means for permitting at least one protocol-source to specify a new communication protocol for future communication between the protocol-source and the system, thereby updating the means for receiving and/or communicating.

2. The system according to claim 1 wherein the protocol-source is at least one context data source.

3. The system according to claim 1 wherein the protocol-source is at least one of the applications.

4. The system according to claim 1 wherein the protocol-source is at least one directory service.

5. The system according to claim 1 which includes a protocol registry (404) for storing the new communication protocol.

6. The system according to claim 5 wherein the protocol-source transmits code to perform an implementation of the communication protocol to the protocol registry.

7. A system for processing context data comprising means for receiving context data from a plurality of sources; means for producing context information from the received context data according to a predetermined rule-set including a plurality of rules; and means for communicating the context information to at least one application, characterized in that
the system includes means for permitting at least one rule-source to specify at least one rule thereby updating the rule-set, wherein the rule-source specifies rules for filtering and/or formatting the context data.

8. The system according to claim 7 wherein the rules determined by the rule-source further include rules for producing context information from context data.

9. The system according to claim 7 wherein the rule-source is at least one context data source.

10. The system according to claim 7 wherein the rule-source is at least one of the applications.

11. The system according to claim 7 wherein the rule-set can be updated dynamically.

12. The system according to claim 7 further comprising at least one registry for storing rules specified by the rule-source.

13. The system according to claim 12 which includes a first registry for storing rules for filtering and/or formatting context data and a second registry for storing rules for producing context information.

14. The system according to claim 7 which includes means for notifying the application when a predetermined requirement is met.

15. The system according to claim 14 wherein the predetermined requirement is at least partly determined by the rules specified by the rule-source.

16. The system according to claim 14 which includes an interest registry for storing the rules which determine the predetermined requirements of the application.

17. The system according to claim 1 which includes means for collecting context data.

18. The system according to claim 17 which includes means for translating the context data provided by the sources and providing the context data to the system.

19. The system according to claim 17 wherein the collecting means is a sensor.

20. An apparatus which includes the system for processing context data according to claim 1.

21. The apparatus according to claim 20 which includes a wireless interface.

22. A network for processing context data which includes a system for processing context data according to claim 1, a plurality of data sources for supplying context data to the system for processing context data and a plurality of applications for receiving context information from the system for processing context data.

23. The network according to claim 22 wherein at least one of the systems for processing context data is implemented on the apparatus.

24. The network according to claim 22 wherein at least one of the applications is implemented on the apparatus.

25. The network according to claim 22 wherein at least one of the data sources is on the apparatus.
